(19) United States
(12) Patent Application Publication
(10) Pub. No.: US 2026/0012808 A1
(43) Pub. Date: Jan. 8, 2026

(54) SYSTEM AND METHOD FOR NOMINAL VALIDATION IN NETWORK PLANNING

(71) Applicant: JIO PLATFORMS LIMITED, Ahmedabad, Gujarat (IN)

(72) Inventors: Sandeep RAWAT, Uttarakhand (IN); Haresh B AMBALIYA, Gujarat (IN); Vikram SINGH, Mumbai, Maharashtra (IN); Sundaresh SANKARAN, West Mumbai, Maharashtra (IN); Aayush BHATNAGAR, Navi Mumbai, Maharashtra (IN); Pradeep Kumar BHATNAGAR, Navi Mumbai, Maharashtra (IN)

(73) Assignee: JIO PLATFORMS LIMITED, Ahmedabad, Gujarat (IN)

(21) Appl. No.: 18/992,223

(22) PCT Filed: Feb. 20, 2024
(86) PCT No.: PCT/IN2024/050180

§ 371 Date: Jan. 8, 2025

(30) Foreign Application Priority Data
Feb. 24, 2023 (IN) 202321012783

(51) Int. Cl. H04W 16/18

(52) U.S. Cl. CPC H04W 16/18

(57) ABSTRACT

The disclosed system and method enables auto validation of initial nominals generated from capacity and strategy data sets to obtain an optimal list of sites and cell configurations. The disclosed system and method automates the process of nominal validation by providing a simple web interface on which requirements for a geography are received thus automating an entire process of ingesting huge crowd sourced data, geospatial data and doing predictions and analysis for obtaining the optimal sites.

### RESERVATION OF RIGHTS

A portion of the disclosure of this patent document contains material, which is subject to intellectual property rights such as, but are not limited to, copyright, design, trademark, Integrated Circuit (IC) layout design, and/or trade dress protection, belonging to Jio Platforms Limited (JPL) or its affiliates (herein after referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### TECHNICAL FIELD

The present disclosure relates to a field of wireless networks, and specifically to a system and a method for auto validation of nominals to obtain an optimal list of sites and cell configurations.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Worldwide there are approximately 4 million cell sites radiating 4G networks, which were deployed while focusing on providing only for mobile broadband service. 5G (Fifth Generation) cellular network promises a range of services broadly categorized into enhanced mobile broadband (eMBB), Ultra-reliable and Low-Latency communication (uRLLC) and Massive Machine Type Communications (mMTC). As every service type has different design targets so planning and deployment needs to be tailored for a target service. With wide ranges of possible 5G use cases, aimed to connect millions of devices and humans using higher frequency bands, it is a very cumbersome and complex process to run multiple iterations and obtain an optimal site plan and cell configuration designed for a given coverage and capacity criteria.

This is because the task of network planning is done conventionally by hundreds of engineers using desktop-based tools, which involve huge man-hours for collecting the data, pre-processing followed by radio predictive tasks to determine best possible locations for new proposed sites and cell level physical problems. So, the traditional approach is manual and tedious as well. Few of the challenges faced while using the conventional approach for network planning are involvement of manual and tedious work, undefined planning processes, challenges in dealing with crowd sourced data, steep learning curve in desktop based planning tools, challenges faced in storing and doing spatial queries on geo datasets such as fiber, hotspots, etc.

There is, therefore, a need in the art for an improved system and method that automatically ingests huge crowd sourced data, geospatial data, performs predictions and generates nominal based on different type of requirement & then allow to converge to best optimal sites list & cell configurations using crowd sourced data, geospatial data and predictions.

### SUMMARY

In an exemplary embodiment, a method for performing validation of nominals in network planning for generating a set of optimal sites and cell configurations is described. The method comprises generating, by a nominal generation module, nominals based on a plurality of capacity data and strategy data. The plurality of nominals includes site locations. The method further comprises receiving plurality of inputs from web interface. The input comprises of target area, plurality of target KPIs and initial nominals generated from the capacity data and the strategy data. The method comprises performing, by nomination validation module, nominal validation of the nominals generated based on the plurality of capacity data, strategy data and the plurality of inputs. The method further comprises predicting a set of optimal sites and cell configurations based on the nominal validation and displaying the predicted set of optimal sites and cell configurations on map visualization.

In some embodiments, the capacity data comprises of radio frequency (RF) data, customer device information, building data, fiber route, landmarks, places of interest and target key performance indicators (KPIs), and the strategy data comprises of user-focused strategies, cell-focused strategies, area-focused strategies and building and places of interests (POIs) focused strategies and the KPIs comprises of signal interference to noise ratio (SINR) and reference signal received power (RSRP).

In some embodiment, the map visualization comprises of pre-prediction visualizations of sites and cell configurations and post prediction visualization of final selected optimal site & cell configuration.

In some embodiment, the method further comprises performing the network planning based on at least one of existing network infrastructure and new network infrastructure.

In some embodiment, the method for performing nominal validation comprises processing of the plurality of initial nominals generated based on capacity data & strategy data to cover target area. The method further comprises creating traffic map in nominal validation for optimal sites & cell configuration.

In another exemplary embodiment, a system for performing auto-validation of nominals in network planning is described. The system comprises a nominal generation module configured to generate a plurality of nominals based on a plurality of capacity data and strategy data. The plurality of nominals includes site locations. A web interface configured to receive a plurality of inputs comprising of target areas, plurality of key performance indicators (KPIs) and the plurality of nominals generated from the capacity data and the strategy data. A nomination validation module configured to perform validation of the nominals generated from the capacity data, the strategy data, and the plurality of inputs. A prediction unit configured to predict a set of optimal sites and cell configurations. A display module configured to display coverage, quality requirements, the final optimal sites and cell configuration on map visualization.

In some embodiment, the capacity data comprises of radio frequency (RF) data, customer device information, building data, fiber route, landmarks, places of interest and target key performance indicators (KPIs), and the strategy data comprises of user-focused strategies, cell-focused strategies, area-focused strategies and building and places of interests (POIs) focused strategies and the KPIs comprises of signal interference to noise ratio (SINR) and reference signal received power (RSRP).

In some embodiment, the map visualization comprises of pre-prediction visualizations of sites and cell configurations and post-prediction visualizations of final selected sites and cell configurations.

In some embodiment, the system further comprises performing the network planning based on at least one of existing network infrastructure and new network infrastructure.

In some embodiment, in order to perform nominal validation, the NV module configured to process the plurality of initial nominals generated based capacity data and strategy data to cover the target area. The NV module configured to create traffic map in nominal validation for optimal sites & cell configuration.

The foregoing general description of the illustrative embodiments and the following detailed description thereof are merely exemplary aspects of the teachings of this disclosure and are not restrictive.

### OBJECTS OF THE PRESENT DISCLOSURE

It is an object of the present disclosure to provide a system and a method to auto validate nominals to obtain an optimal list of sites and cell configurations.

It is an object of the present disclosure to streamline site location planning process by automating and stitching all necessary components.

It is an object of the present disclosure to obtain an optimal site/cell list based on inputs used for planning.

It is an object of the present disclosure to meet coverage & quality requirement by selecting optimal site & cell configuration.

It is an object of the present invention to optimize the initial nominals generated from capacity & strategy-based input.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary high-level flow of a Nominal Validation (NV) module, in accordance with an embodiment of the present disclosure.

FIG. 2 illustrates an exemplary End-to-End (E2E) automated system and methodology for 5G planning, in accordance with an embodiment of the present disclosure.

FIG. 3 illustrates exemplary sub processes for the NV module, in accordance with an embodiment of the present disclosure.

FIG. 4 illustrates an exemplary pre-processing flow of NV inputs, in accordance with an embodiment of the present disclosure.

FIG. 5 illustrates an exemplary mechanism for selecting capacity/strategy projects from a User Interface (UI), in accordance with an embodiment of the present disclosure.

FIG. 6 illustrates an exemplary map depicting target area and target Key Performance Indicators (KPIs), in accordance with an embodiment of the present disclosure.

FIG. 7 illustrates an exemplary NV output, in accordance with an embodiment of the present disclosure.

FIG. 8 illustrates exemplary inputs as NG_capacity, and nominal generation based on capacity data in accordance with an embodiment of the present disclosure.

FIG. 9 illustrates exemplary NG_capacity output, in accordance with an embodiment of the present disclosure.

FIG. 10 illustrates exemplary inputs to NG_strategy, nominal generation based on strategy data, in accordance with an embodiment of the present disclosure.

FIG. 11 illustrates an exemplary NG_strategy for enabling a brownfield mode, in accordance with an embodiment of the present disclosure.

FIG. 12 illustrates an exemplary NG_strategy output plan covering major means of transport, in accordance with an embodiment of the present disclosure.

FIG. 13 illustrates an exemplary output, for ABC city, obtained from nominal validation with initial nominals generated from the capacity data and strategy data, in accordance with an embodiment of the present disclosure.

FIG. 14 illustrates a mechanism for performing nominal validation of initial nominals generated from the capacity data and the strategy data, in accordance with an embodiment of the present disclosure.

FIG. 15 illustrates a subprocess, used in the nominal validation, for sites to cellconfig conversion, in accordance with an embodiment of the present disclosure.

FIG. 16 illustrates a subprocess, used in nominal validation, for traffic grid creation, in accordance with an embodiment of the present disclosure.

FIG. 17 illustrates an integrated radio prediction application interface, in accordance with an embodiment of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Upcoming 5G networks are going to be the biggest enabler for industry 4.0 providing high bandwidth, ultra-low latency and massive Internet of Things (IoT) deployments. However, this requires an effective and efficient 5G network planning and deployment. Disclosed is a system and method for automation of an End-to-End (E2E) 5G radio planning. The disclosed system and method provide unique sets of web applications for automated 5G planning and deployment. The disclosed system and method is based on a cloud native architecture which eliminates conventional desktop based planning with the end to end automated planning system using radio prediction application hosted on centralized infrastructure, which is integrated to accept inputs from internal systems & simple web interface to generate optimal planning output & network insights in a time bound manner for making quick business decision.

The disclosed system and method implement an entirely new approach to the planning and design of 5G networks and may be extended to other technologies as well, such as Wi-Fi. Planning of any cellular network requires extensive paperwork and simulation tasks before arriving at any final list of sites. The disclosed system and method perform cellular planning which touches all requirements from network capacity/strategic point of view. Further, all sites location/cell configurations are auto fine-tuned using an integrated radio prediction application interface.

In an embodiment is disclosed a concept of Nominal Validation (NV). The NV involves auto validation of nominals based on strategy inputs and capacity inputs to obtain an optimal list of site and cell configuration. Features of the NV are highlighted below:
Flexible automatic cell planning where multiple workflows may be invoked, such as optimization only or optimization followed by site selection
Auto creation of a traffic map
Defining target areas and target Key Performance Indicators (KPIs)
Supporting greenfield and brownfield sites

For executing the NV, nominals may be generated using two different modules i.e., a Nominal Generation (NG) Capacity module and a Nominal Generation (NG) Strategy module. The NG Capacity module and the NG Strategy module may be referred to herein as NG_Capacity and NG_Strategy, respectively. The NG capacity and the NG strategy modules (also referred to as nominal generation module) may generate nominals (e.g., site locations). The NG capacity and the NG strategy modules are configured to identify the best possible locations to deploy 5G sites over existing 4G infrastructure or as a new nominal. The nominals may be site locations and cell configurations. Using NG capacity module, intended areas over which new generation coverage is to be provided are identified. After identifying the area, the location where new generation site to be deployed is defined to serve the identified area. After identifying the location to deploy the site, orientations and parameters for the site are decided. Using NG strategy module, site locations are identified based on inputs such as key landmarks, major intersection within city, fiber connected users per building, key railways and roadway connectivity points, key junction of road traffic movement along with marketing inputs and details of nearby fiber route and fiber network.

A nominal validation (NV) module may receive nominals generated from each of the NG_Strategy module and the NG_Capacity module for optimal site selection using integrated radio prediction application interface. The radio predication application interface may execute to converge towards best possible Reference Signal Received Power (RSRP) values and Signal-to-Noise Ratio (SINR) values along with optimal sites count with optimized tilt and azimuth. The NV module validates the nominals generated out of the NG_Strategy and the NG_Capacity module using radio predictive algorithms to achieve fine-tuned results, which avoids rework during actual site deployment process.

In an aspect, NV module is configured to perform nominal validation. To perform nominal validation, the NV module is configured to combine nominals received from the NG strategy module and the NG capacity module. The NV module is configured to perform sub-processing of the combined nominals received from NG_capacity module and NG_strategy module to initial cell level data. The sub-processing of combined nominals to the cell level data includes setting of height, azimuth, tilt of cell. The cell level data is fed to the radio prediction application interface. The NV module is configured to receive target area and KPI targets and create traffic map. The NV module is configured to generate set of optimal sites based on processed cell data, the target area, the KPI targets and the traffic map.

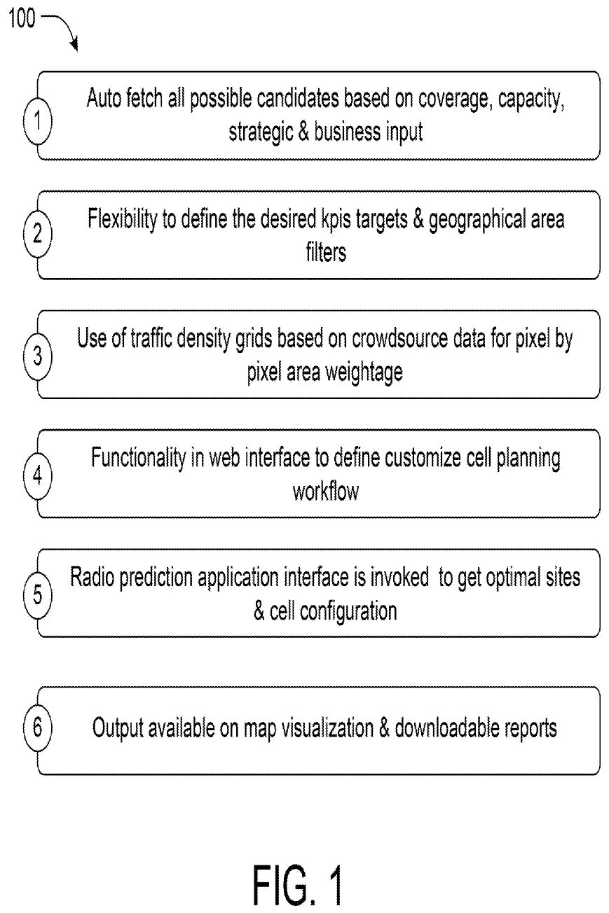

In an embodiment, a prediction unit uses radio prediction application interface (RPA) to evaluate each site to determine final list of optimal nominals (e.g., site locations). The RPA receives processed inputs (e.g., initial nominals) from NG strategy and NG capacity. The RPA also receives target KPIs (e.g., RSRP, SINR) and target areas defined by the user from the web interface. Further, traffic map is created using best server plots & performance traffic. The RPA t may evaluate each site based on inputs from NG strategy and NG capacity modules, target KPIs, target area and traffic map. The list of optimal site locations is determined. In this way, the RPA converges towards best possible RSRP & SINR values along with optimal sites count with optimized tilt & azimuth. FIG. 1 illustrates an exemplary high-level flow 100 of a NV module, in accordance with an embodiment of the present disclosure. As is illustrated, at Step 1, all possible candidates are fetched based on coverage, capacity, strategic and business inputs. At step 2, the desired KPIs target and geographical area filters are defined. In step 3, traffic density grids are created for running predications in the radio predication application interface and deciding the optimal sites and cell configurations. Further, at step 4, a functionality in the web interface to define customized cell planning workflow. At step 5, a radio predication application interface is invoked to get optimal sites and cell configuration. Thereafter, at step 6, an output is generated. The output is available on map visualization. In addition, a downloadable report is also generated for the output. The NV module feature may be accessed by an engineer on web based cognitive platform (CV). Engineer may provide capacity or strategy data & optional custom site list in NV Module web interface. The NV module may return optimal site & cell configuration & results are displayed on the web interface.

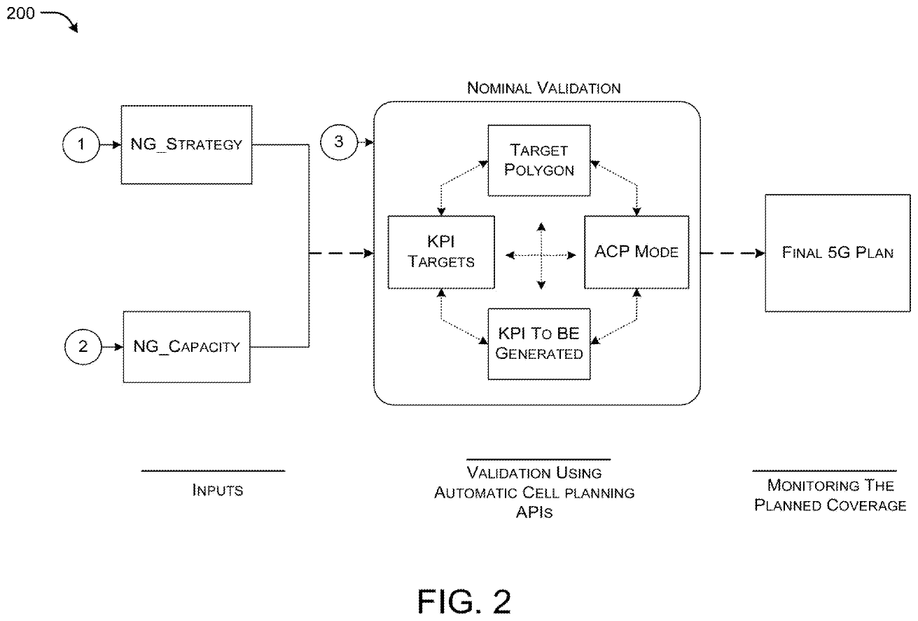

FIG. 2 illustrates an exemplary end to end E2E automated system 200 for 5G planning, in accordance with an embodiment of the present disclosure. E2E automated system has cloud native architecture which eliminates the traditional desktop-based approach. E2E automated system implements automated planning using radio predication application interfaces hosted on centralized infrastructure. This helps in obtaining the optimal planning output & network insights in time bound manner for making quick business decisions. As is illustrated, are the E2E automated system inputs and output relations. The E2E automated system includes a NG_Strategy module, a NG_Capacity module, a nominal validation (NV) module and a monitoring module. The NG_Strategy module and the NG_Capacity module send a nominal site list to an NV Validation module. The NV Validation module triggers coverage prediction simulations for nominals. Prediction simulation includes simulation of the laying of cells, executing cell configurations, operations, obtaining KPIs, and the like, where all radio simulations are performed to obtain a final network plan. The NV module receives inputs from the NG_Stratgey module and the NG_Capacity module. Upon receiving the inputs, the NV module performs validation of the inputs using cell planning workflow. For this the NV module uses a target polygon module, KPI targets module and KPI to be generated module. The NV module uses radio predictions that help to generate optimal nominal list, corresponding cell configurations and cell-level features. On completion of the validation, a final 5G plan is generated for monitoring a planned coverage by the monitoring module. The planned coverage is defined to fulfil all requirements from network capacity/strategic point of view & all sites location/cell configurations are auto fine-tuned.

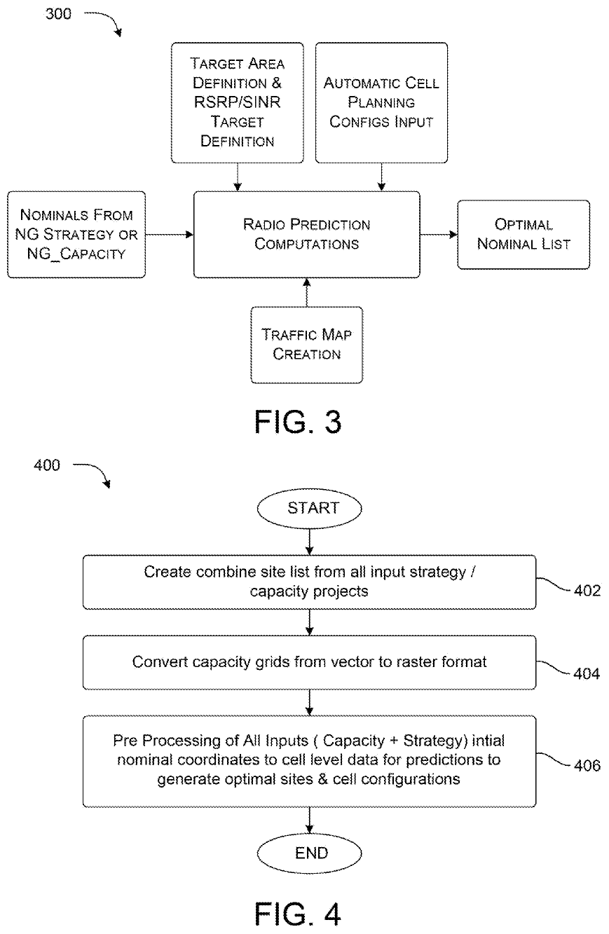

FIG. 3 illustrates exemplary subprocesses 300 for the NV module, in accordance with an embodiment of the present disclosure. As is illustrated, the NV module takes feeds from the NG_Strategy and/or the NG_Capacity modules. Input from the modules is pre-processed to be converted into a format compatible with radio prediction computations. The radio prediction computations receive as input target area definitions and RSRP/SINR target definition, and automatic cell planning configurations input. In addition, traffic map creation parameters are also sent as input to the radio prediction computations. This results in producing an optimal nominal list of cell sites.

FIG. 4 illustrates an exemplary pre-processing flow 400 of the NV inputs, in accordance with an embodiment of the present disclosure.

As is illustrated, at step 402 in flow 400, the NV module takes feeds from strategy or capacity projects. Combinations of multiple capacity and strategy-based inputs provided as inputs.

At step 404 in flow 400, all inputs are pre-processed to convert in a format compatible for radio prediction computations. The received inputs are executed, and NG_Capacity Module may generate high-capacity demand area vector grids. The high-capacity demand area vector grids may be used optionally as target area in the NV module. So, capacity grids are also converted from a vector to an appropriate format supported by the radio prediction application interface.

At step 406 of flow 400, on pre-processing all the input (capacity and strategy projects) site coordinates are transformed to a cell level data to be used for predictions.

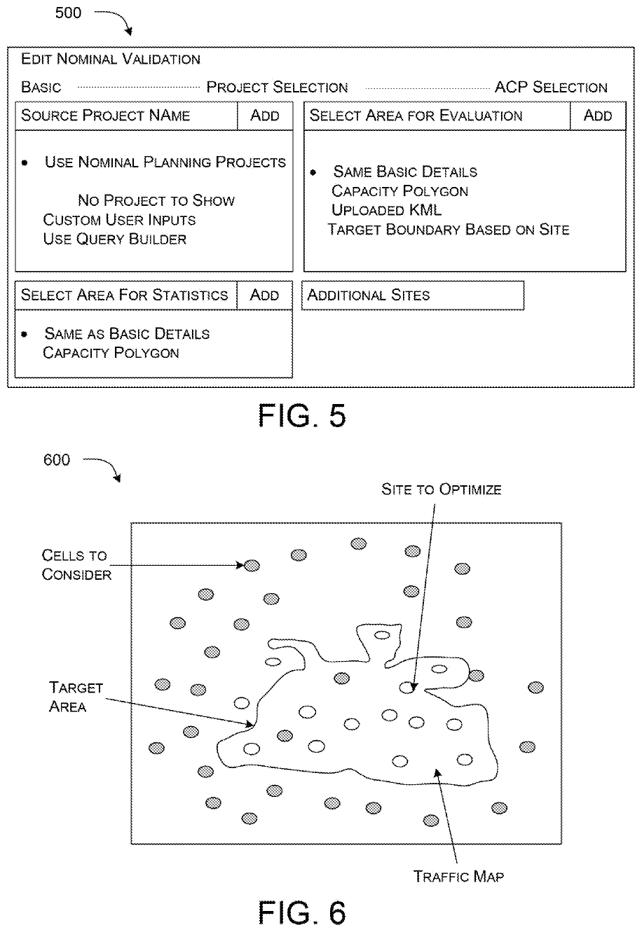

FIG. 5 illustrates an exemplary mechanism 500 for selecting capacity/strategy projects from a User Interface (UI), in accordance with an embodiment of the present disclosure.

In an embodiment are disclosed details related to post processing of the inputs received from the NG_Capacity module and the NG_Strategy module. Site (lat-long level data) to cell level data conversion is done before doing the radio prediction. Depending on solution type, site category and morphology, appropriate site template is used to convert site level data to cell level.

In an embodiment, a cell is created only on the basis of ‘solution type’. Templates are some default standard cell configurations. Template_ODSCX means a default cell configuration template with number of ODSC=X.

TABLE 1
Cell creation on basis of ‘solution type’ only

| Solution Type | Template to be used |
|---|---|
| Solution type = 1 + 0 | Use site template “template_ODSC1” |
| Solution type = 1 + 1 | User site template “template_ODSC2” |
| Solution type = GNB | Use site template “template_GNB” |

In an embodiment, a cell is created on basis of both ‘solution type’ and ‘site category’:

TABLE 2
Cell creation on basis of both ‘solution type’ and ‘site category’

| Site | | | |
|---|---|---|---|
| category/ | ODSC1 | ODSC2 | |
| solution Type | (1 + 0) | (1 + 1) | GNB |
| New Nominal | 9 m, | 9 m, (0 & | 25 m, (0, 120, 240 |
| | (0 deg) | 180 deg) | deg) |
| 4G_Macro | 15 m, | 15 m, (0 & | Height same as 4G macro, |
| | (0 deg) | 180 deg) | 0, 120, 240 deg |
| Fiberized Route | 9 m, | 9 m, (0 & | 25 m, (0, 120, 240 deg) |
| | (0 deg) | 180 deg) | |
| Fiberized Building | | | 25 m, (0, 120, 240 deg) |
| 4G_SmallCell | 9 m, | 9 m, (0 & | 25 m, (0, 120, 240 deg) |
| | (0 deg) | 180 deg) | |

After converting the site level data to the cell level data, wherever site category=4G_Macro or 4G_smallcell, for all those records height is updated. Further, height/azimuth, tilt (min [10, total tilt]) is set as equal to value as present in the 4G network.

FIG. 6 illustrates an exemplary map 600 depicting target area and target KPIs, in accordance with an embodiment of the present disclosure. In order to obtain the optimal site and the cell configuration, other inputs are passed for defining the target area and the KPI targets. Once the target area is provided as input, then improvement on the KPI is planned, within the defined area only. For determining the target KPIs, the RSRP and the SINR KPI targets are defined. The RSRP may refer to reference signal received power. The RSRP is defined as linear average over the power contributions (in Watts) of the resource elements which carry synchronization signals. The SINR stands for signal-to-noise and interference ratio. The SINR is defined as the linear average over the power contribution (in Watts) of the resource elements carrying synchronisation signals divided by the linear average of the noise and interference power contribution (in Watts) over the resource elements carrying synchronisation signals within the same frequency bandwidth.

The optimal sitelcell selection is done to improve the KPI within the target areas. In case if any existing ON AIR site is present, then that site is also considered during the site selection.

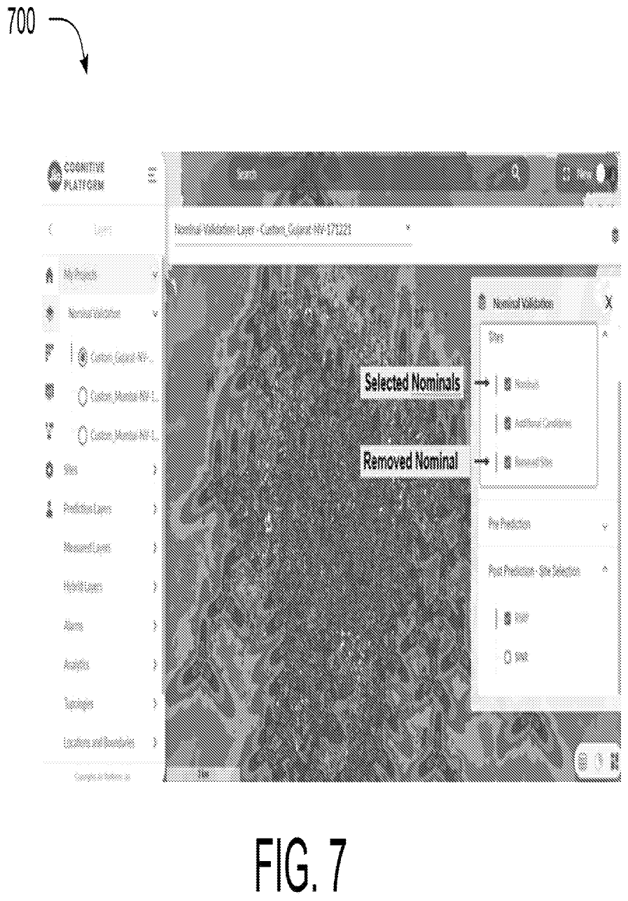

FIG. 7 illustrates an exemplary NV output 700, in accordance with an embodiment of the present disclosure. On determination of the optimal site, the NV output is provided as map visualization and also as a downloadable report.

In an embodiment, are provided key features of the NV as:
Integrated radio prediction application interface

The CP is integrated to an exemplary info vista-planet engine to leverage radio predictive and cell planning workflow. This gives maximal utilization of licenses and hardware, which is often a challenge if doing planning using desktop-based tools.
Flexible cell planning workflow

The user may define its own cell planning workflow to be applied on an input site list. By way of an example, the user may choose to run optimization, then selection and finally the optimization step again.
Built-In 1000 plus workflows using intuitive web interface

To the end user, the NV module is exposed through a simple and intuitive UI.

At the same time, the module supports all practical use cases and scenarios that are available in desktop planning tools.
Integrated NG_Strategy and NG_Capacity module

The NV module provides a direct option on the UI where the user may select the desired nominal planning project (either the NG_Capacity or the NG_Strategy). The inputs are automatically converted and pre-processed for consumption by the planet engine's APIs.
Custom user input mode

Use of this mode allows the users to input a custom site list with configurable pre-cell level parameters such as tilts, azimuth, antenna, power, loading, etc.
Flexible polygon inputs for the KPI improvement

The cell planning algorithm needs target areas where the RSRP and the SINR is to be improved. The NV module offers flexibility to input administrative boundary, import of Keyhole Mark-up Language (KML) and capacity grids. The cell planning algorithm is used for cell optimization & cell selection. In the cell optimization, cell parameters such as height, tilt, azimuth are optimized. In the cell selection, all sites are ranked then optimal list of sites are selected for the RSRP & SINR targets.
Flexible polygon inputs for coverage statistics

Coverage statistics are needed for evaluating the RSRP or any other KPI. Options are present to use administrative boundary, custom KML imports or even capacity grids. So basically, the user may select boundary ‘A’ for the KPI improvement and may select boundary ‘B’ for overall KPI computation. Of course, the boundary ‘A’ has to be a subset of the boundary ‘B’.
Auto ingestion of traffic map

For doing cell selection and optimization, the NV module also uses traffic maps as weighting factors. Usage of the traffic maps gives more accurate planning results. The traffic maps are ingested automatically in the backend and the user is not required to perform any manual work for traffic map creation.
Site template functionality

For doing either simple prediction or automatic cell planning, a huge set of site and cell level details needs to be populated in a tool specific format. In addition, most of the time, few parameters vary from cell to cell and rest of the parameters are the same for all. Using site template functionality, the user may generate a task, such as prediction using few attributes e.g., site name, lat/long and site-template name. If required, the user may provide additional details, such as tilt, height, power, loading to override parameters in the site-template. This feature kills data preparation overheads and no tool specific knowledge is needed for doing prediction or automatic cell planning.
Load Configuration Functionality

This is an administrative feature which empowers an administrator to see all servers and their active or inactive status through the CP interface. The administrator may increase or decrease a number of parallel instances for the NV module using load configuration functionality.
Map visualization and downloadable output

Pre-predictions, and post predictions along with nominal details, are available on map view. Pre-prediction visualization shows the cell before predictions.

The pre-prediction visualization may include target area, cell-radius, cells which need to consider, sites to be optimized, traffic map. As illustrated in FIGS. 6 & 7, cells to consider (e.g., grey shade circles), site to optimize (e.g., white shade circles), target area and traffic map shown in FIG. 6.

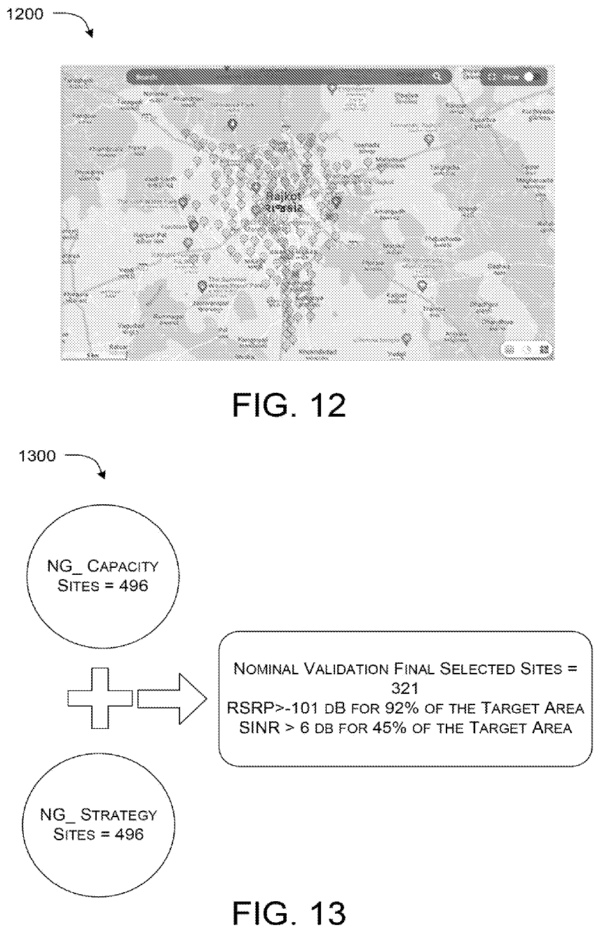

Post-prediction visualization shows the set of optimal sites and cell configurations based on the nominal validation. The post-predication visualization may include nominals (e.g., set of selected optimal site) generated. For example, post-predication visualization provided in FIGS. 12 & 13. As shown in FIG. 12, the selected target area (e.g., ABC). As shown in FIG. 13, NG_CAPACITY sites=496, NG_STRATEGY sites=496, Nominal validation final selected sites=321, RSRP>-101 DB for 92% of the target area, SINR>6 DB for 45% of the target area.
Repository for collaboration

In the repository, all job results created by the user are by default visible to other users.
Raw radio predication application interface configuration download

If an engineer plans to conduct an advance troubleshooting or wants to reuse job's specific data in some desktop tool, then all raw data (sitelcell processed and unprocessed both) can be downloaded in a zip format.

By way of an example, is provided a sample case study with an objective to design a 5G network for provided input specifications. The input specifications include, for example, (a) a brownfield plan for ABC city where target area is defined on basis of the existing 4G usage (capacity grids), (b) prioritize areas with 5G handset concentration and 4G high usage areas, (c) target area should have RSRP>-101 dbm and SINR>6 db with higher weightage to the RSRP, (d) higher priority given to sites on the existing 4G infrastructure, and I all rails, national and state highway should be covered.

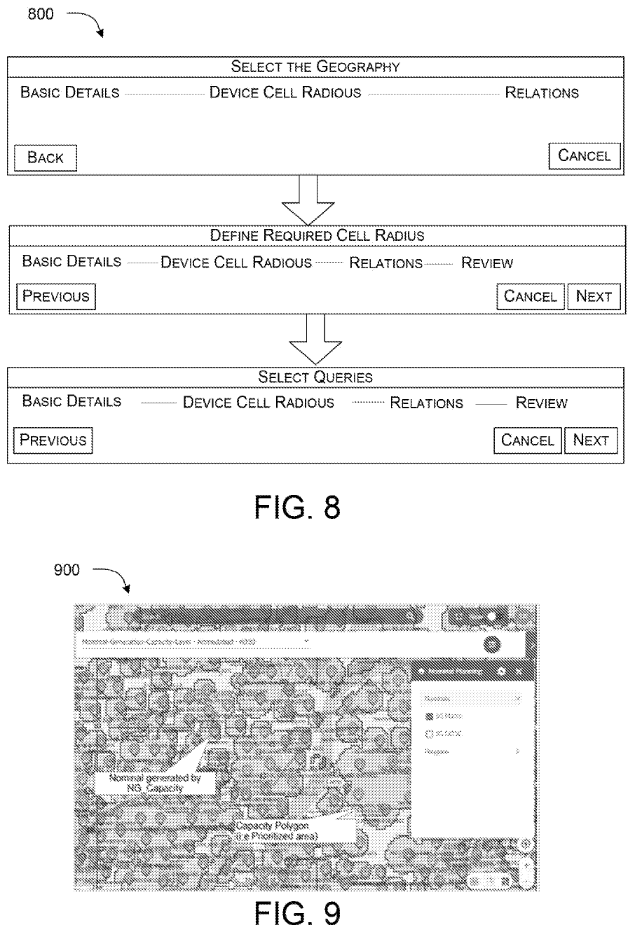

Design requirements related to defining the target area, basis the 4G usage and the 5G handset concentration and fiber site prioritization may be fulfilled using the NG_Capacity module. The design requirements for prioritizing the areas with 5G handset concentration and high 4G usage may be implemented by providing queries for “Grid Selection”, “Adjacent Grid for 5G gNB”, “5G gNB Selection” and “5G ODSC Selection”. FIG. 8 illustrates exemplary inputs 800 as NG_capacity, in accordance with an embodiment of the present disclosure. The inputs are provided with respect to selecting geography, defining required cell radius, and selecting queries. Discussed below are a few sample queries:

$$GridSelection \text{:} [ “ Morphology != ‘ Water\_Body ’ AND Morphology !=$$

$$‘ Dense\_Vegetation ’ AND ( Total\_Traffic \_in \_GB > 1. OR POI\_COUNT > 0 OR$$

$$Total\_Dense \_Usage \_Duration \_in \_mins > 30 OR$$

$$Total\_ICU \_Usage \_Duration \_in \_mins > 30 OR$$

$$Total\_Hospitalized \_Usage \_Duration \_in \_mins > 30 OR$$

$$( unique\_user \_count \_ 5 G ) > 0 ) ” ] .$$

This query for GridSelection accounts for the design requirement of prioritizing the target areas based on 5G handsets and the 4G usage.

$$5 G gNB Selection \text{:} \text{} [ Total\_Traffic \_in \_GB > 150 OR POI\_COUNT > 0 OR$$

$$( Total\_Traffic \_in \_GB > 75 AND$$

$$( DeadDominantCellCount + ICUDominantCellCount + HospitalizedDominantCellCount / TotalDominantCellCount ) > 0.5 )$$

This query accounts for criteria, which may be used for placing the gNB at prioritized areas. It may be noted that by default the NG_Capacity module produces plan in the Brownfield mode as well as a Greenfield mode by providing nearest available site and coordinate of prioritized area i.e., centroid Coordinates. The greenfield may refer to a low-capacity network and the brownfield may refer to a high-capacity network. The greenfield mode may enable without legacy network and brownfield mode may enable on top of existing legacy network.

FIG. 9 illustrates exemplary NG_capacity output 900, in accordance with an embodiment of the present disclosure.

TABLE 3
Case Study 1 NG_Capacity input/output details for ABC city.

| | |
|---|---|
| 1- 1- Target City: ABC city boundary | Total Nominal |
| 2- Desired Cell Radius: DU -200 m, U | Generated = 496 |
| 250 m, SU 300 m & RU-500 m | Total gNB = 440 sites |
| 3- Grid selection inputs for generating 5G | (284 on existing |
| serving locations (Target area) | fiberized macro) |
| Unique 5G handsets in 60 × 60 m > 0 OR | Total ODSC = 56 sites |
| Total 4G usage in 60 × 60 m should be | (6 on existing |
| more than 1 GB or | fiberized macro) |
| Point of Interest >0 OR | |
| Poor 4G users experience mou >30 min | |
| per day | |
| (Dead/ICU/Hospitalized cells) | |
| Exclude Water bodies & Dense | |
| vegetation | |
| 4- gNB Selection Inputs | |
| Total 4G usage in desired cell radius | |
| should be more than 150 GB | |
| 5- 5G ODSC selection Inputs | |
| Total 4G usage in desired cell radius | |
| should be more than 80 GB | |

Further, for rail, national and state highway coverage, strategy modules may be used. The NG_Strategy module may generate all optimal nominals collocated on existing 4G sites (wherever possible) to cover all national and state highways.

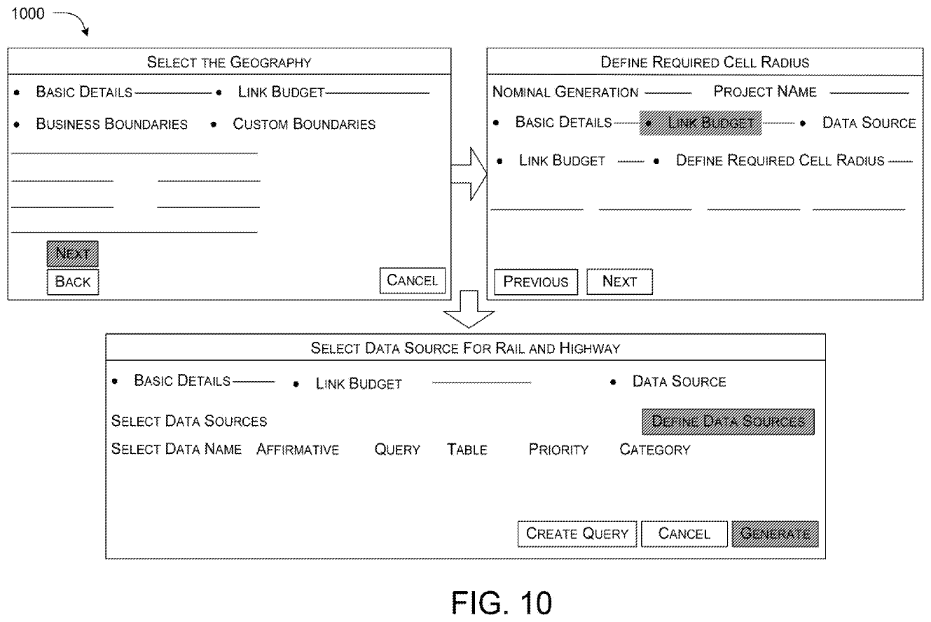

FIG. 10 illustrates exemplary inputs 1000 to NG_strategy for selecting data sources, in accordance with an embodiment of the present disclosure.

As illustrated, the geography may select by selecting basic details, link budget, business boundary, custom boundaries. Further, required cell radius is defined by basic details, link budget, data source, defining required cell radius. The data sources are selected for rail and highway by selecting and defining data sources. For defining data sources, select data name, affirmative, query, table, priority, category.

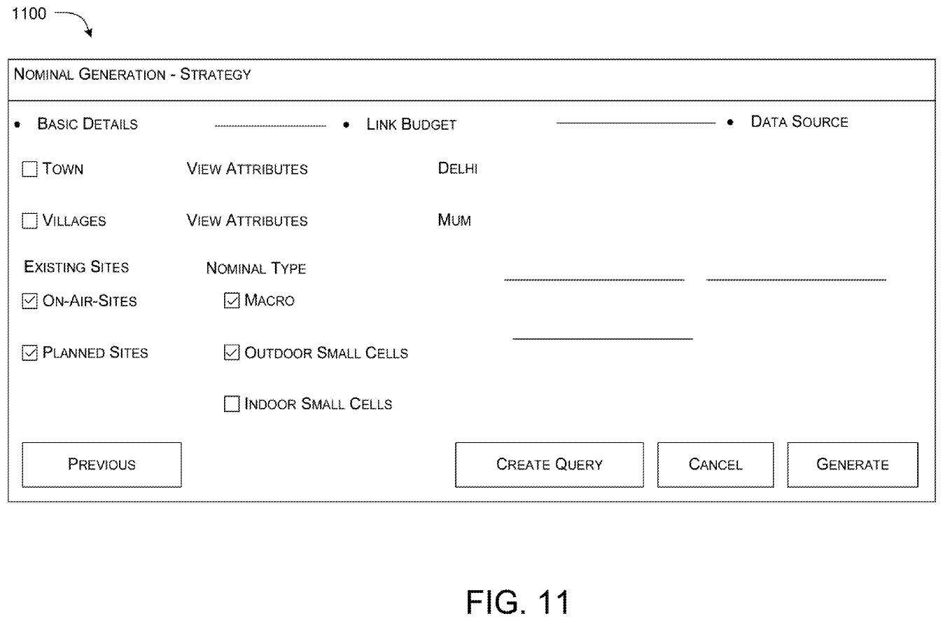

FIG. 11 illustrates an exemplary NG_strategy 1100 for enabling a Brownfield mode, in accordance with an embodiment of the present disclosure. As illustrated, to enable the Brownfield mode, “Existing Sites” option may be selected to reuse either 4G On-Air sites, 4G planned sites or both. Further, on clicking “Generate”, a job may be submitted for nominal generation using NG_Strategy basis the given inputs. Output of this module ensures that it meets the design requirement of covering all the national and state highways with maximal usage of existing sites.

In an embodiment are disclosed inputs to and respective outputs received from the NG_Strategy.

TABLE 4
NG_Strategy input/output details for ABC city

| Inputs to Strategy Module | Output of Strategy Module |
|---|---|
| 1- Target City: Rajkot City Boundary | Total Nominal Generated = 131 |
| 2- Desired ISD: DU -200 m, U 250 m, | Total Nominal for Rails = 38 |
| SU 300 m & RU-500 m | Total Nominal for Roads = 93 |
| 3- Spatial Vectors: Rails & Road | |
| Vectors. Rails having high priority | |
| 4- Brownfield Mode by selecting | |
| existing Macro & ODSC | |

FIG. 12 illustrates exemplary NG_strategy output plan 1200 covering major means of transport, in accordance with an embodiment of the present disclosure. For final validation of NG_Capacity and NG_Strategy sites, the NV module may be used which produces the output as shown in FIG. 12.

FIG. 13 illustrates exemplary brownfield output summary 1300 for ABC city, in accordance with an embodiment of the present disclosure. As is illustrated, by way of an example, a total of 321 sites may be selected out of 496 capacity sites and 131 strategy sites.

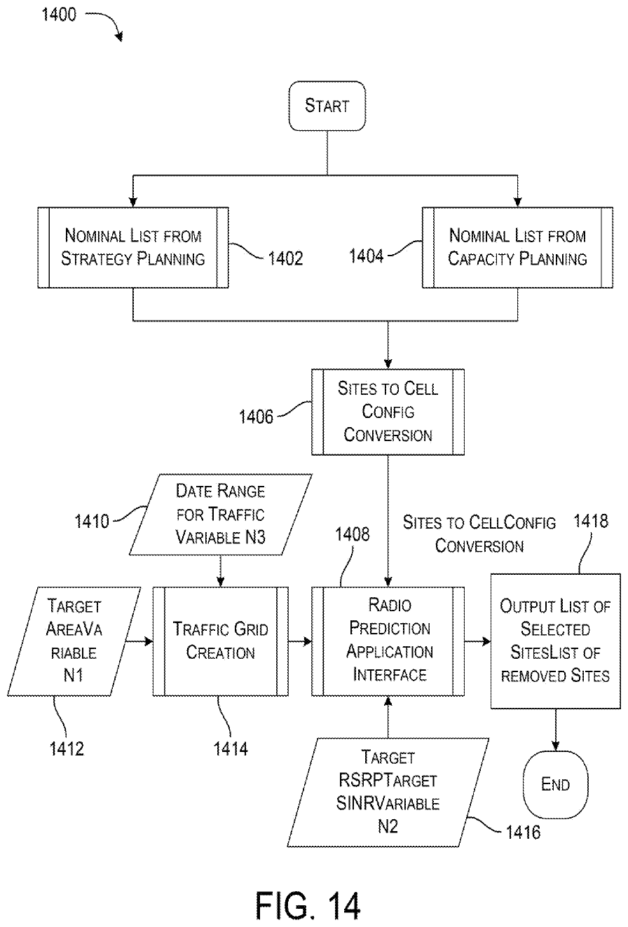

FIG. 14 illustrates a mechanism 1400 for auto network planning validation for telecom, in accordance with an embodiment of the present disclosure. As is illustrated, at step 1402, a list of sites obtained from strategy planning. At step 1404, a list of sites obtained from capacity planning. At step 1406, the nominal lists from strategy planning and capacity planning are used to perform sites to cell config conversion. At step 1408, sites to CELLCONFG conversion are sent as input to a radio predication application interface. At step 1414, traffic grid creation may receive inputs a target area variable N1 (1410) and a data range for traffic variable N3 (1412). The site selection internal process may receive input from the traffic grid creation. The site selection internal process also receives as input a target RSVP and a target SINR variable N2. At step 1418, output from the site selection internal process is an output list of selected sites list of removed sites.

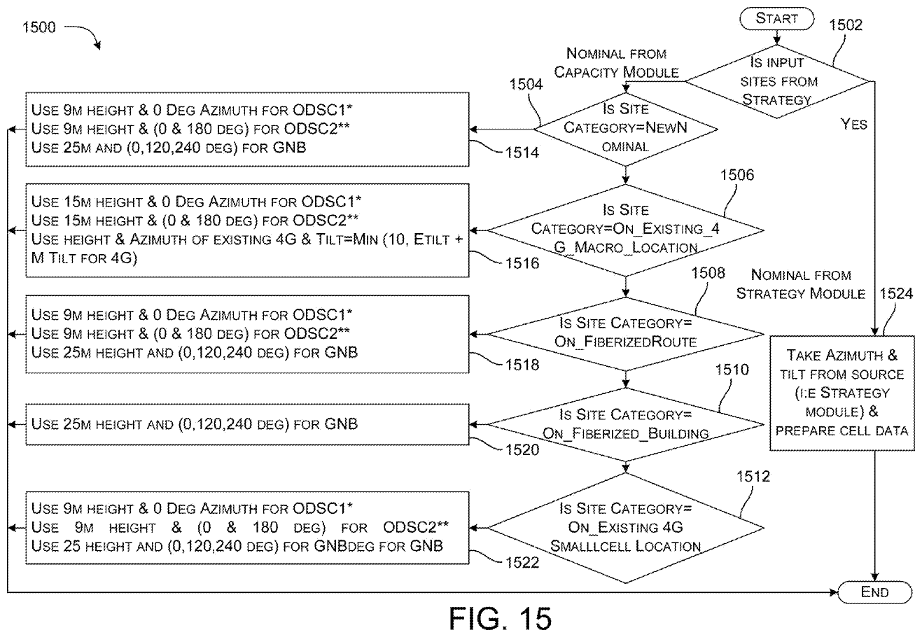

FIG. 15 illustrates a subprocess 1500 for sites to cellconfig conversion, in accordance with an embodiment of the present disclosure. As is illustrated, at step 1502, it is determined if input sites form strategy. At step 1504, if it is a nominal from capacity module it is determined if the site category=new nominal. At step 1514, instructions received are:
use 9 m height and 0 deg azimuth for odsc1*
use 9 m height & (0 & 180 deg) for odsc2**
use 25 m height and (0,120,240 deg) for gNB.

At step 1506, if the site category=on_existing_4G_macro_location,

At step 1516, the instructions received are:
use 15 m height and 0 deg azimuth for odsc1*
use 15 m height & (0 & 180 deg) for odsc2**
use height and azimuth of existing 4G and tilt=min (10, e tilt+m tilt for 4G)

At step 1508, if the site category=on_fiberized route,

At step 1518, the instructions received are:
use 9 m height and 0 deg azimuth for odsc1*
use 9 m height & (0 & 180 deg) for odsc2**
use 25 m height and (0,120,240 deg) for gNB.

At step 1510, if the site category=on_fiberized_building,

At step 1520, the instructions received are:
use 25 m height and (0,120,240 deg) for gNB.

At step 1512, If the site category=on_fexisting 4G small cell location,

At step 1522, the instructions received are:
in use 9 m height & 0 deg azimuth for odsc1*
use 9 m height & (0 & 180 deg) for odsc2**
use 25 height and (0,120,240 deg) for gnbdeg) for gNB

However, at step 1524, if the input site from strategy has a nominal from strategy module, then an azimuth and tilt is taken from the source (i.e., strategy module) and a cell data is prepared.

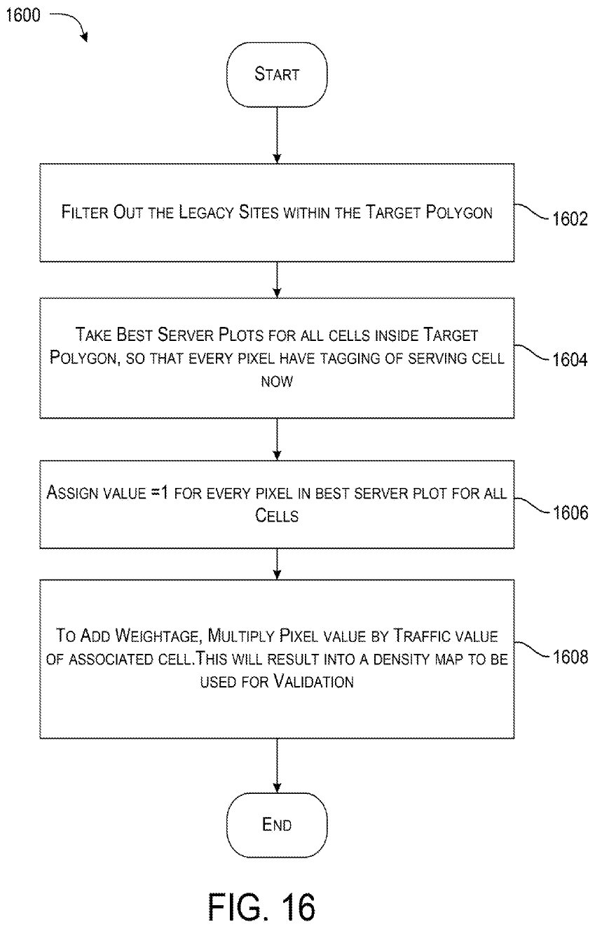

FIG. 16 illustrates a subprocess 1600 for traffic grid creation, in accordance with an embodiment of the present disclosure.

As illustrated, at step 1602, legacy sites are filtered out from the target polygon.

Next, at step 1604, best server plots are taken for all cells inside the target polygon so that every pixel has tagging of the serving cell.

At step 1606, A value=1 is assigned for every pixel in the best server plot for all cells.

At step 1608, to add weightage, pixel value is multiplied by traffic value of associated cell leading to producing a density map to be used for validation.

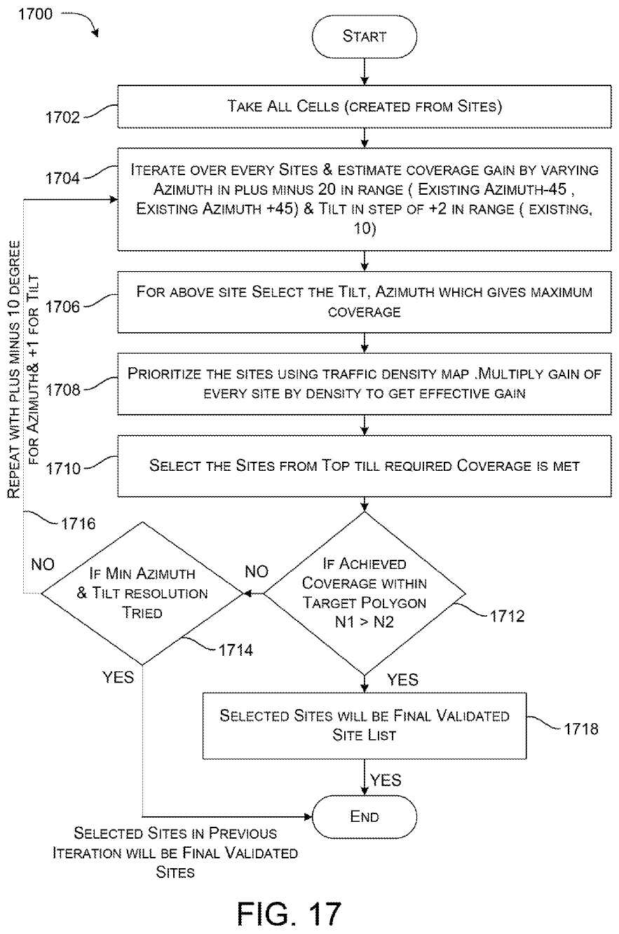

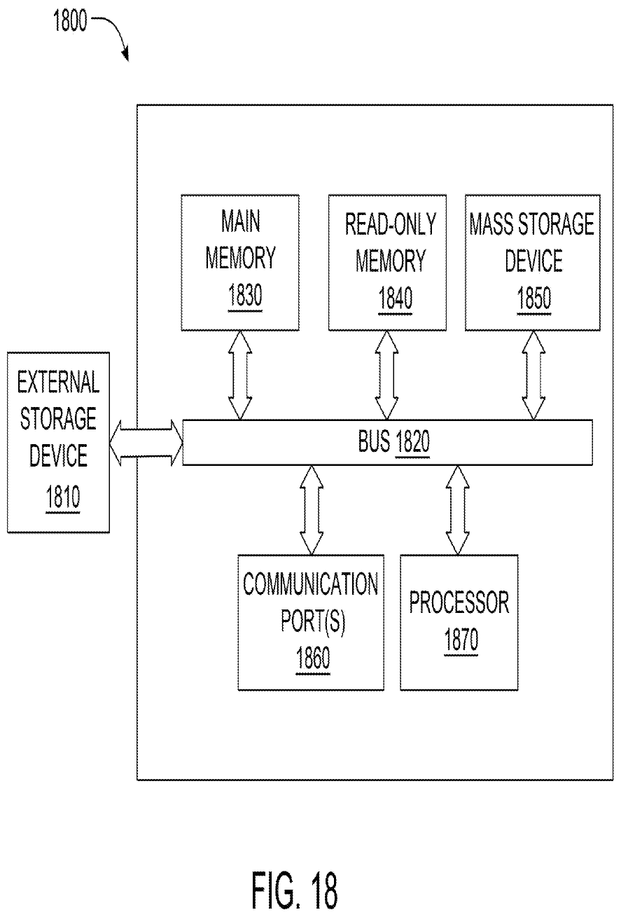

FIG. 17 illustrates a subprocess 1700 for defining an internal process for site selection, in accordance with an embodiment of the present disclosure. As illustrated, at step 1702, all cells created from the sites are obtained. Further, at step 1704, an iteration over every site is performed and a coverage gain is estimated by varying azimuth in plus minus 20 in range and tilt in step of +2 in range.

At step 1706, for the above site, the tilt and the azimuth is selected which gives maximum coverage.

Next, at step 1708, the sites are prioritized using a traffic density map. Here, the gain of every site is multiplied by density to obtain effective gain.

At step 1710, the sites are selected from top till required coverage is met.

At step 1712, checking if achieved coverage within target polygon N1>N2.

At step 1714, if the required coverage is not within target polygon N1>N2, checking minimum azimuth and tilt resolution are tried.

At step 1716, if minimum azimuth and tilt resolution are not tried, then the above-mentioned steps are repeated with plus minus 10 degrees for azimuth and +1 for tilt.

At step 1718, if achieved coverage is within target polygon N1>N2, selected sites will be the final validated site list or the selected sites in previous iteration will be final validated sites.

The disclosed system and method streamline the planning process by automating and stitching all necessary components. Within a few minutes an engineer can pass all inputs for planning and determining optimal site\cell list.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Present Disclosure

The present disclosure supports auto validation of nominals to obtain an optimal list of sites and cell configurations.

The present disclosure streamlines a site location planning process by automating and stitching all necessary components.

The present disclosure obtains an optimal site/cell list based on inputs used for planning.

The present disclosure provides strategies which are either user focused, cell focused, area focused, or building/Point of Interest (POI) focused.

The present disclosure supports both greenfield and brownfield mode.

The present disclosure provides rich geospatial data sets integration such as fiber boundary, rail, roads, building, key landmark areas, town, and village boundary, etc.

The present disclosure provides optimized nominals for concrete planning of the network.

We claim:

1. A method for performing validation of nominals in network planning for generating a set of optimal sites and cell configurations, the method comprising:
generating, by a nominal generation module, a plurality of nominals based on a plurality of capacity data and strategy data, wherein the plurality of nominals includes site locations;
receiving, by a web interface, a plurality of inputs, wherein the inputs comprise of target areas, plurality of target key performance indicators (KPIs) and the plurality of nominals generated from the capacity data and strategy data;
performing, by a nomination validation module, validation of the nominals generated from the capacity data, the strategy data and the plurality of inputs by integration with a radio simulation tool; and
displaying coverage and quality requirements, predictions and visualization of final optimal sites and cell configuration associated with a validated nominal.

2. The method as claimed in claim 1, wherein capacity data comprises radio frequency (RF) data, customer device information, building data, fiber route, landmarks, places of interest and target key performance indicators (KPIs), and the strategy data comprises of user-focused strategies, cell-focused strategies, area-focused strategies and building and places of interests (POIs) focused strategies and the KPIs comprises of signal interference to noise ratio (SINR) and reference signal received power (RSRP).

3. The method as claimed in claim 1, wherein the map visualization comprises of pre-prediction visualizations of sites and cell configurations and post-prediction visualizations of final selected optimal sites and cell configurations.

4. The method as claimed in claim 1 further comprises, performing the network planning based on at least one of existing network infrastructure and new network infrastructure.

5. The method as claimed in claim 1, wherein performing the nominal validation comprising:
processing the plurality of initial nominals generated from the capacity data and the strategy data;
triggering coverage prediction simulations for nominals; and
identifying optimal sites and cell configuration.

6. A system for performing validation of nominals in network planning for generating a set of optimal sites and cell configurations comprising:
a nominal generation module configured to generate a plurality of nominals based on a plurality of capacity data and strategy data, wherein the plurality of nominals includes site locations;
a web interface configured to receive a plurality of inputs comprising of target areas, plurality of target key performance indicators (KPIs) and the plurality of nominals generated from the capacity data and the strategy data;
a nominal validation module configured to perform validation of the nominals generated from the capacity data, the strategy data, and the plurality of inputs;
a prediction unit configured to predict a set of optimal sites and cell configurations based on the nominals; and
a display module configured to display coverage, quality requirements, the final optimal sites and cell configuration on map visualization associated with a validated nominal.

7. The system as claimed in claim 6, wherein the capacity data comprises of radio frequency (RF) data, customer device information, building data, fiber route, landmarks, places of interest and target key performance indicators (KPIs), the strategy data comprises of user-focused strategies, cell-focused strategies, area-focused strategies and building and places of interests (POIs) focused strategies, and the KPIs comprises of signal interference to noise ratio (SINR) and reference signal received power (RSRP).

8. The system as claimed in claim 6, wherein the map visualization comprises of pre-predication visualizations of sites and cell configurations and post-prediction visualizations of final selected optimal sites and cell configurations.

9. The system as claimed in claim 6 wherein the nomination validation module configured to perform the network planning based on at least one of existing network infrastructure and new network infrastructure.

10. The system as claimed in claim 6, wherein the nomination validation module is further configured to:
process the plurality of initial nominals generated from the capacity data and the strategy data;
trigger coverage prediction simulations for the nominals; and
identify optimal sites and cell configuration.

11. A computer program product comprising a non-transitory computer-readable medium comprising instructions that, when executed by one or more processors, cause the one or more processors to execute a method for performing validation of nominals in network planning for generating a set of optimal sites and cell configurations, the method comprising:
generating, by a nominal generation module, a plurality of nominals based on a plurality of capacity data and strategy data, wherein the plurality of nominals includes site locations;
receiving, by a web interface, a plurality of inputs, wherein the inputs comprise of target areas, plurality of target key performance indicators (KPIs) and the plurality of nominals generated from the capacity data and strategy data;
performing, by a nomination validation module, validation of the nominals generated from the capacity data, the strategy data and the plurality of inputs by integration with a radio simulation tool; and
displaying coverage and quality requirements, predictions and visualization of final optimal sites and cell configuration associated with a validated nominal.

12. A computer program product comprising a non-transitory computer-readable medium comprising instructions that, when executed by one or more processors, cause the one or more processors to execute a system for performing validation of nominals in network planning for generating a set of optimal sites and cell configurations comprising:
a nominal generation module configured to generate a plurality of nominals based on a plurality of capacity data and strategy data, wherein the plurality of nominals includes site locations;
a web interface configured to receive a plurality of inputs comprising of target areas, plurality of target key performance indicators (KPIs) and the plurality of nominals generated from the capacity data and the strategy data;
a nominal validation module configured to perform validation of the nominals generated from the capacity data, the strategy data, and the plurality of inputs;
a prediction unit configured to predict a set of optimal sites and cell configurations based on the nominals; and
a display module configured to display coverage, quality requirements, the final optimal sites and cell configuration on map visualization associated with a validated nominal.
